(19) United States
(12) Patent Application Publication
(10) Pub. No.: US 2011/0163666 A1
(43) Pub. Date: Jul. 7, 2011

(54) Flat Lamp with Elastic Frame

(75) Inventor: Klaus-Dieter Bauer, Landau (DE)

(73) Assignee: OSRAM GESELLSCHAFT MIT BESCHRÄNKTER HAFTUNG, Muenchen (DE)

(21) Appl. No.: 13/061,675

(22) PCT Filed: Aug. 11, 2009
(86) PCT No.: PCT/EP2009/060380

§ 371 Date: Mar. 1, 2011

(30) Foreign Application Priority Data
Sep. 1, 2008 (DE) 10 2008 045 343.9

(51) Int. Cl. H01J 61/30; H01J 9/38

(52) U.S. Cl. 313/634; 445/39

(57) ABSTRACT

A flat lamp comprising a flat discharge vessel, which encloses a discharge volume with two plates (1, 2) which are separated from one another by way of a frame (3), wherein the frame (3) includes a region which is elastically deformable in the direction of the spacing between the plates.

### TECHNICAL FIELD

The invention relates to a flat lamp comprising a discharge vessel that consists essentially of two opposite plates separated from one another by way of an elastic frame.

### PRIOR ART

In such gas discharge lamps, the light is produced in a discharge volume between the separated plates, the spacing between the plates being relatively small relative to the length and generally also the width of the plates. The discharge vessel of such a lamp, therefore, has a flat, plate-like shape overall, in which at least one of the plate sides is used for discharging light over a large surface area and at the same time the discharge vessel has a small overall height.

### DESCRIPTION OF THE INVENTION

The object of the invention is to improve the discharge vessel of a flat lamp.

To this end, the invention relates to a flat lamp comprising a flat discharge vessel which encloses a discharge volume with two plates which are separated from one another by way of a frame, wherein the frame comprises a region which is elastically deformable in the direction of the spacing between the plates.

The invention further relates to a method for producing such a flat lamp.

Preferred embodiments of the invention are provided in the dependent claims and are also revealed from the following description. The disclosure is thus understood to be made with regard to the device aspect and the method aspect of the invention.

Due to their particular geometric design, flat lamp discharge vessels are only able to dissipate forces which are produced as a result of a difference in pressure between the interior of the discharge vessel and the atmosphere, through the external vessel walls of the frame, without further measures being taken. The forces thus lead to stresses in the large-surface plates which are subjected to the pressure and may lead to the discharge vessel bursting. The difference in pressure is thus determined principally by the filling pressure of the interior comprising a gas used for producing light and the temperature thereof, a distinct negative pressure usually prevailing relative to the atmosphere surrounding the vessel.

In order to prevent the discharge vessel from bursting, therefore, the spaced-apart plates of the flat lamp are usually supported against one another, for example by means of additional spacers or even by means of bulged portions or raised portions of at least one of the plates which bridge the spacing between the plates.

The idea of the present invention is an elastic frame which determines the spacing between the plates. If a force acts on the plates, due to a difference in pressure between the interior of the discharge vessel and the atmosphere, this leads to an alteration of the spacing, by the elastic frame yielding, so that the discharge volume enclosed by the discharge vessel is also altered. Thus the pressure inside the vessel is equal to the external pressure, at least to an extent which is determined by the elastic restoring forces of the frame. The forces acting on the plates are reduced and thus the risk of bursting reduces and/or larger and/or thinner plates may also be used. As a whole, therefore, the invention also permits the production of flat lamps having a larger luminous surface and/or having thinner plates.

To this end, the frame according to the invention has an elastically deformable region which preferably extends along the entire periphery of the frame. The elastic region thus permits an elastic alteration of the entire frame thickness perpendicular to the frame opening. The frame thickness is thus influenced by a force (acting perpendicular to the frame opening) and, provided no further forces act, the spacing of the plates spaced apart by the frame is dependent on the difference in pressure between the gas-filled interior and the surrounding atmosphere of the discharge vessel.

The discharge vessel of a flat lamp according to the invention thus has a flexible discharge volume which, in particular, is adapted to the filling gas and thus reduces a difference in pressure relative to atmospheric pressure, even at a raised operating temperature. In a preferred embodiment, the spacing between the plates may be altered by elastic deformation of the frame until the difference in pressure is preferably progressively in this sequence at most 500 mbar, 300 mbar or 100 mbar.

Preferably, the frame (in the relaxed state) is of the same thickness along its entire periphery, so that the boundary surfaces of the frame opening are located parallel with one another on both sides. As a result, in a particularly preferred form of the discharge vessel, the plates which are spaced apart by the (relaxed, unloaded) frame are also located parallel to one another.

The plates of the lamp preferably have a (preferably load-bearing) layer made of glass and may have any contour, in particular, a rectangular contour shape.

It is possible for the plates to be spaced apart only by the frame so that all forces transmitted thereto are only transmitted between said plates through the frame. In particular, therefore, the discharge vessel has no additional spacers or even further, optionally elastic, support elements for a mechanical connection between the plates.

Preferably, the elastically deformable region of the frame is an elastically flexible wall. If the frame is then acted upon by a force perpendicular to the frame opening, the elastic wall is twisted, i.e. deformed so that the frame thickness is altered in this direction, but the wall thickness not substantially.

In an advantageous embodiment, the cross-sectional profile of the frame in this elastic region, or even in a further region, may extend in a direction deviating from the direction of the spacing between the plates. As a result of the “oblique” position thus defined, the frame may bulge out at that point, i.e. be inclined further, when by the application of force the thickness of the frame perpendicular to the frame opening is reduced. Additionally, the region extending obliquely may conversely with an elastic return permit an increase in the frame thickness by a progressive alignment in the direction of the spacing between the plates.

Thus an elastically flexible wall is also conceivable, which in the relaxed state extends parallel to the spacing between the plates and which when twisted acts almost as a joint adjacent to an adjoining oblique region. Preferably, however, the obliquely extending region is itself flexible.

Such an obliquely extending elastic region may be conceived, for example, in the form of a conventional folding bellows according to the prior art, i.e. for example with a fold-like, wave-like or lamellar wall profile. Thus in such an embodiment the elastically deformable region of the frame may also comprise just one fold and/or half wave train.

Particularly preferred is a cross-sectional profile of the elastic region with a rounded U-shape, the arms thereof extending parallel to the plates. Bringing the plates closer together, combined with the elastic compression of the frame, therefore, leads to the arms being brought closer together and at the same time to a greater curvature of the base of the U-shaped profile. Conversely, increasing the spacing between the plates leads to an increase in the spacing of the arms with simultaneous stretching of the curved base in the direction of the increased spacing between the plates. In addition to the U-shaped cross-sectional profile of the elastically deformable region of the frame, as mentioned above, further profile shapes are conceivable; for example, said profile shapes may have a (circular or elliptical) annular segment-shaped profile portion or even a cross section with at least one acute, obtuse or right angle.

In a preferred embodiment of the discharge vessel, preferably the plates are (directly) fastened to the frame, for example bonded or preferably fused on. To this end, a so-called glass solder may be used, which is melted by appropriate heating and produces a bond between the frame and the plates.

In particular, even with a direct bond between the frame and the plates, at least in the region adjacent to the plates, the frame and the plates may have coefficients of thermal expansion which differ from one another, progressively in this sequence, preferably by at most a factor of 2, 1.5 or 1.3. As a result of the coefficients of thermal expansion which progressively coincide, stresses between the plates and the frame may be reduced. As a result, the coefficients of thermal expansion are intended to coincide, in particular, in the temperature range to which the discharge vessel is subjected during production and operation and which may be approximately −20° C. to +500° C.

The elastic region may comprise metal, for example an elastically flexible metal wall. In a preferred embodiment, the entire frame is made from metal.

For adapting the coefficients of thermal expansion of such a frame and the plates, preferably a metal with a volume magnetostriction effect is used in which by means of suitable alloy components and the concentration ratio thereof the coefficient of thermal expansion of the metal may be adapted to that of the plate material.

In a particularly preferred embodiment, said metal is an iron-nickel alloy. Said iron-nickel alloy may preferably have a nickel component of progressively at least 35%, 40%, 43% and at most 60%, 55%, 50%. These iron-nickel alloys may also contain further alloy components and non-metallic components, in particular manganese, carbon and silicon, but also cobalt, chromium, titanium, niobium, molybdenum or copper. Particularly suitable are the so-called pernifer alloys, in particular pernifer 46 and pernifer 48. The coefficients of thermal expansion thereof in the relevant temperature range are well suited to glasses which are practically relevant, in particular modified soda-lime glasses.

The flat lamp may, in particular, be a dielectrically impeded gas discharge lamp. In this case, the electrodes may be attached flat to just one of the plates or even to both plates.

Preferably, the discharge vessel is filled with a discharge gas which may comprise xenon and, particularly preferably, a mixture comprising at least xenon and neon. Similarly, gases, for example, comprising helium, argon, krypton, the halogens, in particular chlorine, or mercury, are conceivable.

In a particularly preferred embodiment, in the discharge vessel a xenon partial pressure prevails, progressively in these sequences, of preferably at least 30 mbar, 50 mbar or 80 mbar and at most 500 mbar, 300 mbar or 150 mbar.

Moreover, a fluorescent material may be applied to one plate and preferably to both plates, by means of which the spectral distribution, in particular also the colors, of the light emitted by the lamp may be adjusted. However, fluorescent material may also be dispensed with in order to utilize the UV spectrum directly.

A lamp according to the invention may be designed both to discharge the light on both sides, i.e. through both plates, and on one side through just one of the plates. In the last-mentioned embodiment, the plate which is not provided for the discharge of light may have a reflective layer, in order to increase the light emitted through the opposing plate.

Moreover, the invention permits a cost-effective production of flat lamps as, as already mentioned above, no additional measures have to be taken for (mutual) support of the opposing plates. Instead, by reducing the difference in pressure inside and outside the discharge vessel, the forces acting on the surface of the plates may be reduced so that in a particularly preferred embodiment the plates, at least the load-bearing layers which are preferably made from glass, may in each case have planar surfaces on both sides. In particular, no specific relief portions of the plates which assist the statics of the discharge vessel are necessary. The plates for a discharge vessel may thus be easily cut off from conventional large-surface plate material.

Preferably, for filling the lamp vessel with a filling gas at least one of the plates is not (yet) sealingly connected to the frame. In a further step, for sealing the discharge vessel said plate(s) is/are fastened sealingly to the frame, for example by the action of heat using a fusible substance or a substance which is able to be cured by heat, namely glass solder. Both when filling and when fastening the (glass) plates to the frame, high temperatures are advantageous during production, in particular for heating up the plates and the frame and during the aforementioned fastening of the plates to the frame. As the discharge vessel cools down again after these production steps, the filling pressure drops in the interior.

### BRIEF DESCRIPTION OF THE DRAWING(S)

The invention is described in more detail hereinafter with reference to an exemplary embodiment, the individual features also being able to be essential for the invention in other combinations and referring both to the device aspect and to the method aspect of the invention, in which:

FIG. 1 shows a section through a flat lamp according to the invention with the discharge vessel open,

FIG. 2 shows a plan view of the flat lamp of FIG. 1,

FIG. 3 shows a section through the lamp of FIG. 1, during the closure of the heated discharge vessel and

FIG. 4 shows a section through the discharge vessel of FIG. 1 in the closed state at room temperature.

### PREFERRED EMBODIMENT OF THE INVENTION

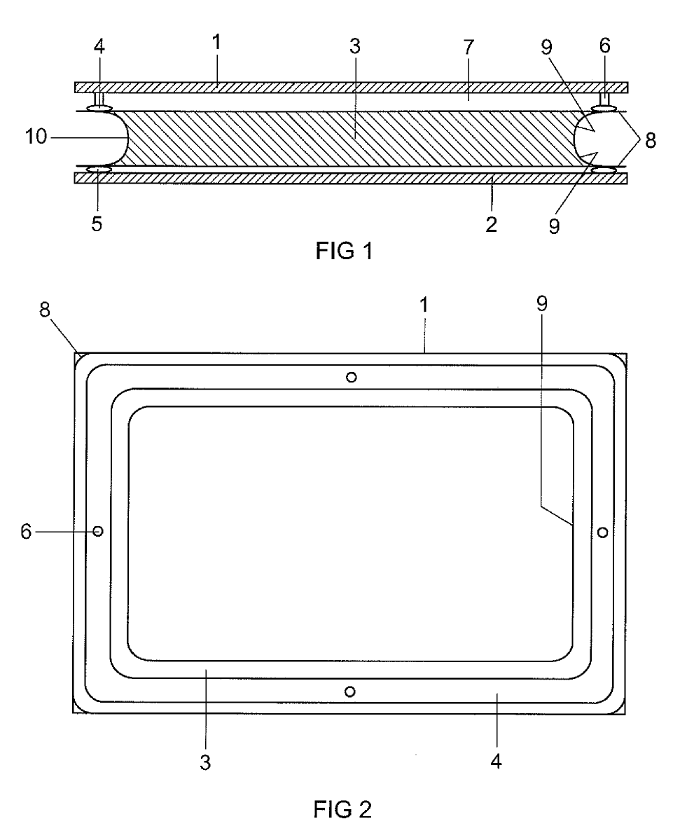

FIG. 1 shows a section through the discharge vessel of a dielectrically impeded gas discharge lamp according to the invention comprising two plates 1, 2 which are spaced apart by a frame 3. For greater clarity, the electrodes, the dielectrical layer, the fluorescent coatings of the plates 1, 2 and a reflective coating of the lower plate 2 have not been illustrated in the figures.

The lamp shown is a flat lamp, the geometry of the discharge vessel thereof being substantially determined by the plates 1, 2. The plates have a rectangular contour and thus also determine the outer shape of the flat lamp, namely a rectangle (see FIG. 2).

The plates 1, 2 are made from a colorless, highly transparent crown glass (modified soda-lime glass, in this case Schott B270) with a planar surface in each case on both sides and the frame 3 made from the iron-nickel alloy pernifer 46 or pernifer 48.

The frame 3 has a U-shaped cross-sectional profile with outwardly open arms 8. Thus the arms 8 of the U-shaped profile are used for supporting the plates 1, 2 whilst the base of the U-shaped profile has oblique elastic regions 9 which, in particular, also extend obliquely relative to the spacing between the plates, i.e. the vertical direction in FIG. 1. The base of the U-shaped profile also has a (small) portion 10 which extends (almost) parallel to the direction of the spacing between the plates; however the wall is primarily oblique relative to this direction. A comparison with FIG. 4 (see below) shows the elastic behavior of the frame 3, in which the arms 8 of the U-shaped profile and thus also the glass plates 1, 2 are brought together, by increased bending of the oblique regions 9 of the U-shaped profile, which in this case represent an elastic wall and apply an elastic restoring force. The portion 10 along the spacing between the plates is thus shortened further due to the oblique region 9 which is progressively aligned parallel to the plates.

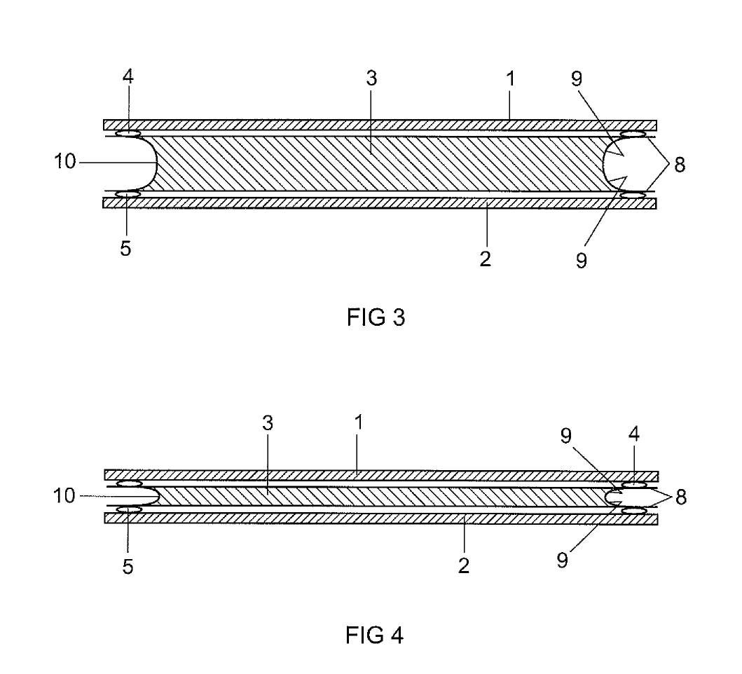

FIG. 1 shows a step during the production of the flat lamp, in which in each case a bead 4, 5 of glass solder, i.e. a glass granulate with a binding agent, is already applied to the frame 3 on both sides along its periphery, i.e. namely the rectangular contour of the plates 1, 2. In this case, Schott G 018-158 is used, which also has a suitable coefficient of thermal expansion. The upper plate 1 is thus additionally spaced apart by glass solder spacers 6 (which are not peripheral) from the frame 3, so that in this step at a temperature of 500° C. and a pressure of 1000 mbar the filling gas, a Xe—Ne gas mixture with 10% xenon and 90% neon, penetrates through the joining gap 7 into the discharge vessel. As the frame in this case is only acted upon by a force through the mass of the upper plate 1, it adopts its (almost) maximum thickness and the elastic wall of the frame in this case, in comparison with FIG. 3, is stretched on the now lengthened portion 10 of the cross-sectional profile in the direction of the spacing between the plates.

FIG. 2 shows, in a plan view of the rectangular flat lamp, that both plates 1, 2 are spaced apart by the frame 3 (see also FIG. 1), in this case superimposed in a congruent manner, the frame 3 extending along the edges of the plates 1, 2, due to a frame opening which is as large as possible. The frame 3 thus terminates at the outside flush with the arms 8 of its U-shaped profile with the plates 1, 2. No further devices supporting the plates are attached between the plates 1, 2.

FIG. 3 shows a further production step which follows that shown in FIG. 1 and in which the temperature is increased to 550° C., i.e. 823 K. At this temperature, the glass solder 4, 5, 6 is significantly softened and seals the discharge vessel after the spacers 6 are softened and collapse. As a result, the interior of the discharge vessel and the atmosphere are separated from one another in a gas-tight manner, in each case a pressure of approximately 1 bar prevailing in both the interior of the discharge vessel and the atmosphere, unchanged relative to FIG. 1.

FIG. 4 shows a further subsequent step during the production of the flat lamp as a section through the closed flat lamp discharge vessel after cooling to a room temperature of 22° C., i.e. 295 K. By cooling from 823 K to 295 K, the discharge volume comprising the filling gas is reduced and the pressure drops. By the resulting difference in pressure, the frame 3 according to the invention yields elastically to this application of force. As a result, the discharge volume at room temperature reduces, according to the temperature ratio, to approximately 36% of the discharge volume at 823 K in FIG. 3. As a result, the internal pressure only alters slightly, namely only according to the increase in restoring forces of the elastically deformed frame 3, said frame now having a greater curvature of the base 9 of its U-shaped cross-sectional profile.

Moreover, it is not only the filling gas which exhibits a temperature-dependent expansion, but also the glass of the plates 1, 2 and the metal of the frame 3.

The glass has the following average longitudinal coefficients of thermal expansion α in 10⁻⁶K⁻¹ for the respectively provided temperature ranges: a (20° C.; 100° C.)=7.8; α (20° C.; 200° C.)=8.8; α (20° C.; 300° C.)=9.4, a (20° C., 400° C.)=9.8; α (20° C.; 500° C.)=10.3.

The aforementioned alloys pernifer 46 and 48 are iron-nickel alloys comprising approximately 45.0-46.0% by weight and/or 47.0-49.0% by weight nickel, no more than 0.8% by weight manganese, no more than 0.5% by weight silicon and no more than 0.1% by weight carbon and exhibit an optimized volume magnetostriction effect. They are namely adapted to the longitudinal coefficients of expansion of the glass of the plates 1, 2 and of the glass solder and have the following average longitudinal coefficients of thermal expansion a in 10⁻⁶K⁻¹ depending on the temperature: and namely a (20° C.; 100° C.)=8.4 and/or 9.8; α (20° C.; 200° C.)=8.0 and/or 9.2; α (20° C.; 300° C.)=7.5 and/or 8.8; α (20° C., 400° C.)=7.4 and/or 8.6; a (20° C.; 500° C.)=8.4 and/or 9.1.

As a result, between the glasses and the metal of the frame 3 only small stresses are produced, so that the risk of stress cracks or even bursting of the discharge vessel is markedly reduced.

Moreover, in the inventive flat lamp pressure fluctuations, for example, due to the operating temperature of the lamp, are also advantageously reduced by the elastic frame.

1. A flat lamp comprising a flat discharge vessel, which encloses a discharge volume with two plates which are separated from one another by way of a frame, wherein the frame includes a region which is elastically deformable in the direction of the spacing between the plates.

2. The flat lamp as claimed in claim 1, wherein the plates are only spaced apart by the frame.

3. The flat lamp as claimed in claim 1, wherein the elastically deformable region includes an elastically flexible wall.

4. The flat lamp as claimed in claim 1, wherein the cross-sectional profile of the frame includes a region which extends in a direction deviating from the direction of the spacing between the plates.

5. The flat lamp as claimed in claim 1, wherein plates are fastened to the frame.

6. The flat lamp as claimed in claim 1, wherein the frame and the plates have coefficients of thermal expansion which differ from one another by at most a factor of two.

7. The flat lamp as claimed in claim 1, wherein the frame is made of metal.

8. The flat lamp as claimed in claim 7, wherein the metal has a volume magnetostriction effect.

9. The flat lamp as claimed in claim 8, wherein the frame is an iron-nickel alloy, with at least 35% and at most 60% nickel.

10. The flat lamp as claimed in claim 1, which is a dielectrically impeded gas discharge lamp.

11. The flat lamp as claimed in claim 1, wherein the plates in each ease have a planar surface on both sides.

12. A method for producing a flat lamp as claimed in claim 1, comprising the steps of:
heating the plates and the frame;
filling the opened discharge vessel with a filling gas sealing the discharge vessel; and
cooling the discharge vessel, the spacing between the plates being reduced by compression of the elastic region.
